(19) United States
(12) Patent Application Publication
(10) Pub. No.: US 2018/0362782 A1
(43) Pub. Date: Dec. 20, 2018

(54) ORGANIC-SOLVENT-BASED-HIGH-SOLID INK COMPOSITION FOR GRAVURE PRINTING, AND GRAVURE PRINTING METHOD

(71) Applicant: SAKATA INX CORP., Osaka-shi, Osaka (JP)

(72) Inventors: Toru OGAWA, Osaka (JP); Junichi HARADA, Osaka (JP)

(21) Appl. No.: 16/060,789

(22) PCT Filed: Dec. 11, 2015
(86) PCT No.: PCT/JP2015/084830

§ 371 Date: Jun. 8, 2018

(51) Int. Cl. C09D 11/033; C09D 11/102; C09D 11/037

(52) U.S. Cl. CPC C09D 11/033; B41M 1/10; C09D 11/037; C09D 11/102

(57) ABSTRACT

The present invention provides an organic solvent-based high-solid ink composition for gravure printing which shows good print density, printability, and laminatability even in gravure printing using a shallow cylinder. Provided is an organic solvent-based high-solid ink composition for gravure printing, mainly including: a pigment; a binder resin; and an organic solvent, the high-solid ink composition having a viscosity of 10 to 1000 mPa·s/25° C. and having a viscosity in gravure printing of 12 to 23 s/25° C. in terms of the efflux time from a Zahn cup #3, the pigment including at least one of an organic pigment and an inorganic pigment, the binder resin including a polyurethane resin having at least one of a primary amino group and a secondary amino group at an end, the polyurethane resin in an amount of 30 parts by mass, when dissolved in 70 parts by mass of the organic solvent, providing a solution having a viscosity of 100 to 900 mPa·s/25° C., the pigment and the binder resin satisfying specific conditions.

### TECHNICAL FIELD

The present invention relates to an organic solvent-based high-solid ink composition for gravure printing and a gravure printing method. Specifically, the present invention relates to an organic solvent-based high-solid ink composition for gravure printing which shows good print density, printability, and laminatability even when a shallow printing plate is used in gravure printing, and a gravure printing method using the organic solvent-based high-solid ink composition for gravure printing.

### BACKGROUND ART

Tackling environmental issues is a business topic for which all the types of industries should have a social responsibility. The field of plastic film printing of course has this responsibility.

On the contrary, printing on plastic films commonly uses inks containing a large amount of organic solvent due to restriction of printability, so that it causes much damage on the environment. Thus, manufacturers of inks or printed matter attempt to solve the environmental issues by various approaches such as reducing the amount of organic solvents discharged and developing easy treating methods.

One of such approaches by ink manufacturers is to reduce the amount of more environmentally harmful organic solvents among the solvents contained in inks. In an early stage of development, for example, the ink manufacturers reduced the amount of more environmentally harmful organic solvents, such as aromatic solvents and ketone solvents, contained in inks. In a current stage, they consider not only the types and compositional ratios of organic solvents to be used instead of the harmful ones, but also all the materials used for inks, such as binder resin and additives. This results in practical use of ester-alcohol inks which contain substantially or completely no aromatic and ketone solvents.

On the other hand, printing companies attempt to solve the environmental issues by reducing as much as possible the amount of organic solvents in inks discharged to the atmosphere during printing. One example thereof is to reduce the depth (the depths of cells) of a gravure printing plate to reduce the amount of ink used during printing, thereby reducing the amount of organic solvents discharged to the atmosphere (for example, see Patent Literature 1).

In this attempt, the cell capacity is reduced and the amount of ink composition transferred during printing is reduced as the depth of the gravure printing plate is reduced. Such an approach actually can reduce the amount of organic solvents in the ink composition, but the amount of ink transferred is so small that the resulting ink film contains a small amount of colorant. This disadvantageously results in insufficient print (color) density. Thus, an ink composition containing a pigment at a high concentration is usually used for printing so as to form a thin film having a high pigment concentration.

However, such a high pigment concentration in an ink composition causes the ink to have high viscosity, relatively easily resulting in fogging or poor doctor wipe performance.

In order to prevent such high viscosity of an ink composition, one method is known in which the amounts of other solid matter are reduced. However, this method causes a reduction in the amount of binder resin in the ink composition. Such reduction then causes reduction in proportion of the binder resin to the pigment, resulting in poor cohesive force of an ink film.

### CITATION LIST

### Patent Literature

Patent Literature 1: WO 2007/088733
Patent Literature 2: JP 2013-231122 A

### SUMMARY OF INVENTION

### Technical Problem

As mentioned above, a printing method using a shallow gravure printing plate requires high pigment concentration in the ink composition. In response to such high pigment concentration, binder resin is blended in an amount that prevents the reduction in cohesive force of the film of the ink composition. Unfortunately, such blending of the binder resin then causes high viscosity of the ink, resulting in easy staining on printed matters. If the amount of binder resin is reduced so as to reduce the viscosity, the cohesive force of the ink film is then also reduced, unfortunately resulting in poor wear resistance and poor laminatability in lamination processing.

Therefore, the present invention aims to provide an organic solvent-based high-solid ink composition for gravure printing which shows good print density, printability, and laminatability even in gravure printing using a shallow cylinder.

### Solution to Problem

The present inventors performed studies in order to solve the above problems, and have found the solution to the above problems; in other words, the problems can be solved by the use of at least one of an organic pigment and an inorganic pigment as a pigment and the use of a polyurethane resin having at least one of a primary amino group and a secondary amino group at an end, in particular, a polyurethane resin having a primary amino group at an end, as a binder resin at a specific compositional ratio. This reduces the amount of ink used and the volatile contents in the ink to enable great reduction in the amount of organic solvents discharged to the atmosphere. Also, the above problems can be solved. Thus, the present inventors have completed the present invention.

Specifically, the present invention relates to an organic solvent-based high-solid ink composition for gravure printing, mainly including: a pigment; a binder resin; and an organic solvent, the high-solid ink composition having a viscosity of 10 to 1000 mPa·s/25° C. and having a viscosity in gravure printing of 12 to 23 s/25° C. in terms of the efflux time from a Zahn cup #3, the pigment including at least one of an organic pigment and an inorganic pigment, the binder resin including a polyurethane resin having at least one of a primary amino group and a secondary amino group at an end, the polyurethane resin in an amount of 30 parts by mass, when dissolved in 70 parts by mass of the organic solvent, providing a solution having a viscosity of 100 to 900 mPa·s/25° C., the pigment and the binder resin satisfying the following conditions 1 to 3:

Condition 1: with the pigment being an organic pigment, the amount of the organic pigment being 5 to 20% by mass and the amount of the polyurethane resin being 3 to 20% by mass in the organic solvent-based high-solid ink composition for gravure printing; and the amount of the polyurethane resin being 70 to 200 parts by mass relative to 100 parts by mass of the organic pigment;

Condition 2: with the pigment being an inorganic pigment, the amount of the inorganic pigment being 5 to 70% by mass and the amount of the polyurethane resin being 3 to 20% by mass in the organic solvent-based high-solid ink composition for gravure printing; and the amount of the polyurethane resin being 5 to 60 parts by mass relative to 100 parts by mass of the inorganic pigment; and

Condition 3: with the pigment including both an organic pigment and an inorganic pigment, the amount of the organic pigment being 5 to 20% by mass, the ratio by mass of the inorganic pigment to the organic pigment ((mass of inorganic pigment)/(mass of organic pigment)) satisfying 0<((mass of inorganic pigment)/(mass of organic pigment)<7.0, and the amount of the polyurethane resin being 6 to 20% by mass in the organic solvent-based high-solid ink composition for gravure printing; and the amount of the polyurethane resin being 20 to 200 parts by mass relative to 100 parts by mass of the whole pigments.

In the organic solvent-based high-solid ink composition for gravure printing of the present invention, the polyurethane resin having at least one of a primary amino group and a secondary amino group at an end is preferably obtained by reacting a urethane prepolymer having an isocyanate group at an end which is prepared by reacting a polymer diol and polyisocyanate, with a polyamine compound having at least one of a primary amino group and a secondary amino group at an end.

The polyurethane resin having at least one of a primary amino group and a secondary amino group at an end is preferably obtained by any of the following methods (1) to (4):

(1) a urethane prepolymer having an isocyanate group at an end which is obtained by reacting a polymer diol and polyisocyanate is subjected to chain extension with use of an chain extender to provide a urethane prepolymer having an isocyanate group at an end, and the urethane prepolymer is reacted with a quencher other than a polyamine compound having at least one of a primary amino group and a secondary amino group at both ends and then with a quencher that is a polyamine compound having at least one of a primary amino group and a secondary amino group at both ends, thereby preparing a polyurethane resin having at least one of a primary amino group and a secondary amino group;

(2) a urethane prepolymer having an isocyanate group at an end which is obtained by reacting a polymer diol and polyisocyanate is subjected to chain extension with use of an chain extender to provide a urethane prepolymer having an isocyanate group at an end, and the urethane prepolymer is reacted simultaneously with a quencher other than a polyamine compound having at least one of a primary amino group and a secondary amino group at both ends and a quencher that is a polyamine compound having at least one of a primary amino group and a secondary amino group at both ends, thereby preparing a polyurethane resin having at least one of a primary amino group and a secondary amino group;

(3) a urethane prepolymer having an isocyanate group at an end which is obtained by reacting a polymer diol and polyisocyanate is subjected to chain extension with use of an chain extender to provide a urethane prepolymer having an isocyanate group at an end, and the urethane prepolymer is reacted with a quencher that is a polyamine compound having at least one of a primary amino group and a secondary amino group at both ends, thereby preparing a polyurethane resin having at least one of a primary amino group and a secondary amino group; and

(4) a urethane prepolymer having an isocyanate group at an end which is obtained by reacting a polymer diol and polyisocyanate is reacted with a polyamine compound having at least one of a primary amino group and a secondary amino group at both ends to be subjected to chain extension and reaction termination at the same time, thereby preparing a polyurethane resin having at least one of a primary amino group and a secondary amino group.

The polyurethane resin is preferably a polyurethane resin having a primary amino group at an end.

The organic solvent is preferably a solvent mixture of an ester-based organic solvent and an alcoholic organic solvent.

The organic solvent-based high-solid ink composition for gravure printing of the present invention is preferably to be diluted with an organic solvent to provide an organic solvent-based ink composition for gravure printing prior to gravure printing, wherein the organic solvent is a solvent mixture of an ester-based organic solvent and an alcoholic organic solvent, the ratio of the ester-based solvent and the alcoholic organic solvent ((ester-based organic solvent/alcoholic organic solvent) in the organic solvent-based ink composition for gravure printing is 50/50 to 95/5.

The organic solvent-based ink composition for gravure printing preferably contains 5% by mass or more of propyl acetate as an ester-based solvent.

The present invention also relates to a gravure printing method using the organic solvent-based high-solid ink composition for gravure printing, the method including: preparing an organic solvent-based ink composition for gravure printing by diluting the organic solvent-based high-solid ink composition for gravure printing with an organic solvent; and producing printed matter by gravure printing using the organic solvent-based ink composition for gravure printing and a shallow gravure cylinder.

The term “organic solvent-based high-solid ink composition for gravure printing” as used herein means an ink composition adjusted to have a high pigment concentration in such a manner that, when it is diluted with an organic solvent or an ink medium prior to printing, it can provide a predetermined color density and viscosity. The term “organic solvent-based ink composition for gravure printing” as used herein means an ink composition prepared by diluting the organic solvent-based high-solid ink composition for gravure printing with an organic solvent or an ink medium to provide a predetermined color density and viscosity in gravure printing.

The term “a polyurethane resin having at least one of a primary amino group and a secondary amino group at an end” as used herein means a polyurethane resin having at least one of a primary amino group and a secondary amino group at all of or part of ends of the main chain and side chains.

The viscosity of the organic solvent-based high-solid ink composition for gravure printing herein is a value measured using a B-type viscometer (Tokyo Keiki Inc.).

The organic solvent-based high-solid ink composition for gravure printing of the present invention will be described in detail below.

### <Pigment>

The pigment may be any of various inorganic pigments and organic pigments commonly used for printing inks.

Examples of the inorganic pigments include colored pigments such as titanium oxide, colcothar, Antimony red, Cadmium yellow, Cobalt blue, Prussian blue, ultramarine, carbon black, and graphite, and extenders such as silica, calcium carbonate, kaolin, clay, barium sulfate, aluminum hydroxide, and talc, and pearl pigments such as aluminum pastes containing aluminum particles surface-treated with an acrylic resin and mica having a surface coated with titanium oxide, tin oxide, and zirconium oxide.

Examples of the organic pigments include soluble azo pigments, insoluble azo pigments, azo lake pigments, condensed azo pigments, copper phthalocyanine pigments, and condensed polycyclic pigments.

The amount of the pigment in the organic solvent-based high-solid ink composition for gravure printing of the present invention is 5 to 20% by mass, preferably 6 to 15% by mass, when the pigment is an organic pigment, and the amount is 5 to 70% by mass, preferably 5 to 60% by mass, when the pigment is an inorganic pigment.

For combination use of an organic pigment and an inorganic pigment, the amount of the organic pigment is preferably 5 to 20% by mass and the ratio by mass ((mass of inorganic pigment)/(mass of organic pigment)) of the inorganic pigment to the organic pigment preferably satisfies 0<((mass of inorganic pigment)/(mass of organic pigment))<7.0. Mainly known is combination use of an organic pigment and an inorganic extender.

If the amount of the pigment in the organic solvent-based high-solid ink composition for gravure printing of the present invention is smaller than the above range, the high-solid ink composition tends to have poor pigmenting power when it is formed into an ink composition, and thus tends to be incompatible with a shallow gravure printing plate. If the amount thereof is larger than the above range, the high-solid ink composition may disadvantageously have high viscosity, resulting in easy staining on printed matters in gravure printing.

### <Binder Resin>

The organic solvent-based high-solid ink composition for gravure printing of the present invention contains, as the binder resin, a polyurethane resin having at least one of a primary amino group and a secondary amino group at an end.

The polyurethane resin having at least one of a primary amino group and a secondary amino group at an end is preferably obtained by reacting a urethane prepolymer having an isocyanate group at an end which is obtained by reacting a polymer diol and polyisocyanate, with a polyamine compound having at least one of a primary amino group and a secondary amino group at an end.

The polyurethane resin having at least one of a primary amino group and a secondary amino group at an end exhibits a markedly higher effect of dispersing pigments than common binder resins used for ink compositions, and therefore does not lower the cohesive force of the film of the ink composition even when the pigment concentration in the ink composition is high. Accordingly, the organic solvent-based high-solid ink composition for gravure printing containing the polyurethane resin having at least one of a primary amino group and a secondary amino group at an end can show good print density, printability, and laminatability even in gravure printing using a shallow printing plate.

The polyurethane resin is preferably a polyurethane resin having a primary amino group at an end.

The polyurethane resin having at least one of a primary amino group and a secondary amino group at an end is preferably prepared by any of the following methods (1) to (4).

(1) A urethane prepolymer having an isocyanate group at an end which is obtained by reacting a polymer diol and polyisocyanate is subjected to chain extension with use of a chain extender to provide a urethane prepolymer having an isocyanate group at an end, and the urethane prepolymer is reacted with a quencher other than a polyamine compound having at least one of a primary amino group and a secondary amino group at both ends and then with a quencher that is a polyamine compound having at least one of a primary amino group and a secondary amino group at both ends, thereby preparing a polyurethane resin having at least one of a primary amino group and a secondary amino group.

(2) A urethane prepolymer having an isocyanate group at an end which is obtained by reacting a polymer diol and polyisocyanate is subjected to chain extension with use of an chain extender to provide a urethane prepolymer having an isocyanate group at an end, and the urethane prepolymer is reacted simultaneously with a quencher other than a polyamine compound having at least one of a primary amino group and a secondary amino group at both ends and a quencher that is a polyamine compound having at least one of a primary amino group and a secondary amino group at both ends, thereby preparing a polyurethane resin having at least one of a primary amino group and a secondary amino group.

(3) A urethane prepolymer having an isocyanate group at an end which is obtained by reacting a polymer diol and polyisocyanate is subjected to chain extension with use of an chain extender to provide a urethane prepolymer having an isocyanate group at an end, and the urethane prepolymer is reacted with a quencher that is a polyamine compound having at least one of a primary amino group and a secondary amino group at both ends to be subjected to chain extension and reaction termination, thereby preparing a polyurethane resin having at least one of a primary amino group and a secondary amino group.

(4) A urethane prepolymer having an isocyanate group at an end which is obtained by reacting a polymer diol and polyisocyanate is reacted with a polyamine compound having at least one of a primary amino group and a secondary amino group at both ends to be subjected to chain extension and reaction termination at the same time, thereby preparing the polyurethane resin having at least one of a primary amino group and a secondary amino group.

The polyisocyanate may be one of or a mixture of two or more of aromatic diisocyanate compounds such as tolylene diisocyanate, alicyclic diisocyanate compounds such as 1,4-cyclohexane diisocyanate and isophorone diisocyanate, aliphatic diisocyanate compounds such as hexamethylene diisocyanate, and aromatic aliphatic diisocyanate compounds such as α,α,α′,α′-tetramethylxylylene diisocyanate. Preferably, one of or a mixture of two or more of an alicyclic diisocyanate, an aliphatic diisocyanate, and an aromatic aliphatic diisocyanate is used.

Examples of the polymer diol compound include polyalkylene glycols such as polyethylene glycol and polypropylene glycol, polyether diol compounds such as alkylene oxide (e.g., ethylene oxide or propylene oxide) adducts of bisphenol A, and polyester diol compounds such as polyester diols and polycaprolactone diols obtainable by condensation reaction of one or more dibasic acids (e.g., adipic acid, sebacic acid, and phthalic anhydride) and one or more glycols (e.g., ethylene glycol, propylene glycol, 1,4-butane diol, neopentyl glycol, and 3-methyl-1,5-pentane diol). These polymer diol compounds may be used alone or in combination of two or more.

The above polymer diol compounds may be used together with one of or a mixture of two or more of alkane diols such as 1,4-pentane diol, 2,5-hexane diol, and 3-methyl-1,5-pentane diol and low molecular weight diol compounds such as ethylene glycol, propylene glycol, 1,4-butane diol, and 1,3-butane diol.

If the organic solvent to be mentioned later is a solvent mixture of an ester-based solvent and an alcoholic solvent, a polyether diol compound is preferably used as a polymer diol compound because it tends to give a higher solubility to the resulting polyurethane resin and such a highly soluble polyurethane resin increases the number of possible designs of the ink in accordance with required properties.

Regarding the ratio between the polyisocyanate and the polymer diol compound, the equivalent ratio (isocyanate index) of isocyanato groups to hydroxy groups is preferably 1.2:1 to 3.0:1, more preferably 1.3:1 to 2.0:1. If the isocyanate index is smaller than 1.2, the resulting polyurethane resin tends to be flexible. Thus, the polyurethane resin may preferably be used together with another hard resin in some cases when the resulting ink composition provides poor blocking resistance after printing, for example.

The chain extender used in the methods (1) to (3) may be a known chain extender used in polyurethane resin as a binder for ink. Examples thereof include aliphatic diamines such as ethylenediamine, propylenediamine, tetramethylenediamine, and hexamethylenediamine, alicyclic diamines such as isophoronediamine and 4,4′-dicyclohexylmethanediamine, polyamines such as diethylenetriamine and triethylenetetratriamine, aromatic diamines such as toluylenediamine, aromatic aliphatic diamines such as xylenediamine, hydroxy-containing diamines such as N-(2 hydroxyethyl)ethylenediamine, N-(2 hydroxyethyl)propylenediamine, and N,N′-di(2 hydroxyethyl)ethylenediamine, and diol compounds such as ethylene glycol, propylene glycol, 1,4-butane diol, neopentyl glycol, diethylene glycol, and triethylene glycol.

The quencher used in the methods (1) and (2) may be, for example, a polyamine compound having at least one of a primary amino group and a secondary amino group at both ends, a monoamine compound, and/or a monoalcohol compound.

The quencher used in the method (3) may be, for example, a polyamine compound having at least one of a primary amino group and a secondary amino group at both ends.

A compound used for chain extension and reaction termination at the same time used in the method (4) may be, for example, the chain extender alone or a combination of the chain extender and the quencher.

In view of storage stability and pigment dispersibility, the polyurethane resin is preferably obtained by reaction terminating 10% to 100% of isocyanate groups in the urethane prepolymer having an isocyanate group at an end after the chain extension using a quencher that is a polyamine compound having a primary amino group at both ends.

Examples of the polyamine compound having at least one of a primary amino group and a secondary amino group at both ends include aliphatic diamines such as ethylenediamine, propylenediamine, tetramethylethylenediamine, and hexamethylenediamine, alicyclic diamines such as isophoronediamine and 4,4′-dicyclohexylmethanediamine, polyamines such as diethylenetriamine and triethylenetetratriamine, aromatic diamines such as tolylendiamine, aromatic aliphatic diamines such as xylenediamine, and hydroxy-containing diamines such as N-(2-hydroxyethyl)ethylenediamine and N-(2-hydroxyethyl)propylenediamine.

Examples of the quencher that can be used together with the polyamine compound having at least one of a primary amino group and a secondary amino group at both ends include monoamine compounds and monoalcohol compounds which are known quenchers used for polyurethane resin as a binder for ink. Specific examples thereof include monoalkylamines such as n-propylamine and n-butylamine, dialkylamines such as di-n-butylamine, alkanolamines such as monoethanolamine and di-ethanolamine, and monoalcohols such as ethanol.

The present invention can utilize a known method of producing a polyurethane resin from the above materials. Since the hardness of the resulting polyurethane resin depends on the molecular weights, chemical structures, and equivalent ratios of the respective components, the printability and the laminatability can be adjusted by appropriately combining these components.

The polyurethane resin in the organic solvent-based high-solid ink composition for gravure printing of the present invention preferably has a number average molecular weight of 10000 to 70000, more preferably 10000 to 50000.

The amount of polyurethane resin in the organic solvent-based high-solid ink composition for gravure printing of the present invention is appropriately adjusted according to the type and amount of the pigment to be used. The amount of polyurethane resin satisfies one of the following conditions 1 to 3. Satisfying one of the following conditions 1 to 3 allows an organic solvent-based ink composition for gravure printing, which is obtainable by diluting the organic solvent-based high-solid ink composition for gravure printing of the present invention with an organic solvent, to show good print density, printability, and laminatability as in the case of conventional solvent-based ink compositions for gravure printing even in gravure printing using a shallow cylinder.

Condition 1: with the pigment being an organic pigment, the amount of the organic pigment being 5 to 20% by mass, the amount of the polyurethane resin being 3 to 20% by mass, preferably 5 to 15% by mass; and the amount of the polyurethane resin being 70 to 200 parts by mass, preferably 70 to 150 parts by mass relative to 100 parts by mass of the organic pigment.

Condition 2: with the pigment being an inorganic pigment, the amount of the inorganic pigment being 5 to 70% by mass, the amount of the polyurethane resin being 3 to 20% by mass, preferably 5 to 15% by mass; and the amount of the polyurethane resin being 5 to 60 parts by mass, preferably 5 to 40 parts by mass relative to 100 parts by mass of the inorganic pigment.

Condition 3: with the pigment including both an organic pigment and an inorganic pigment, the amount of the organic pigment being 5 to 20% by mass, the ratio by mass of the inorganic pigment to the organic pigment ((mass of inorganic pigment)/(mass of organic pigment)) satisfying 0<((mass of inorganic pigment)/(mass of organic pigment)<7.0, and the amount of the polyurethane resin being 6 to 20% by mass; and the amount of the polyurethane resin being 20 to 200 parts by mass, preferably 20 to 150 parts by mass relative to 100 parts by mass of the whole pigments.

When the polyurethane resin is dissolved in an organic solvent, the viscosity of this solution depends on the types and ratios of the materials used in the synthesis of the polyurethane resin, and the composition of the organic solvent to be mentioned later.

In the present invention, the viscosity of a solution of the polyurethane resin (30 parts by mass) in the organic solvent to be mentioned later (70 parts by mass) is adjusted to 100 to 900 mPa·s/25° C.

If the viscosity of the polyurethane resin solution is lower than 100 mPa·s/25° C., the cohesive force of the ink film tends to be poor. If the viscosity is higher than 900 mPa·s/25° C., the print density on printed matters may be poor.

The viscosity of the polyurethane resin solution is preferably 100 to 500 mPa·s/25° C.

The viscosity of the polyurethane resin solution herein is a value measured using a B-type viscometer (Tokyo Keiki Inc.).

In the present invention, cellulose resin, acrylic resin, polyamide resin, viscous resin, and the like resin may supplementarily be used as other binder resins.

### <Organic Solvent>

Examples of the organic solvent include ketone-based organic solvents (e.g., acetone, methyl ethyl ketone, and methyl isobutyl ketone), ester-based organic solvents (e.g., methyl acetate, ethyl acetate, n-propyl acetate, n-butyl acetate, and isobutyl acetate), alcoholic organic solvents (e.g., methanol, ethanol, n-propanol, isopropanol, and butanol), and hydrocarbon solvents (e.g., toluene and methylcyclohexane).

The organic solvent-based high-solid ink composition for gravure printing of the present invention is to be diluted with an organic solvent to provide an organic solvent-based ink composition for gravure printing prior to gravure printing. In consideration of current tackling against environmental issues and printability and drying properties of inks, the organic solvent added here is preferably a solvent mixture of an ester-based organic solvent and an alcoholic organic solvent. The ratio by mass ((ester-based organic solvent)/(alcoholic organic solvent)) of the ester-based organic solvent to the alcoholic organic solvent is preferably 50/50 to 95/5. In view of the printability of inks, 5% by mass or more of propyl acetate is preferably blended as an ester-based solvent.

In order to improve the printability, the organic solvent preferably contains 0.1 to 10% by mass of water.

### <Additives>

The organic solvent-based high-solid ink composition for gravure printing of the present invention may contain any of additives such as tackifiers, crosslinkers, lubricants, antiblocking agents, antistatic agents, and surfactants.

### <Method of Producing the Organic Solvent-Based High-Solid Ink Composition for Gravure Printing of the Present Invention>

The organic solvent-based high-solid ink composition for gravure printing of the present invention can be produced from the above materials using any of conventionally commonly used dispersing and kneading devices.

The viscosity of the high-solid ink composition is adjusted to 10 to 1000 mPa·s by controlling the amounts of solid materials and the combination of polyurethane resin and organic solvent. If the viscosity is too low, the dispersion stability of materials such as a pigment may possibly be low. If the viscosity is too high, a large amount of diluting solvent may possibly be required for diluting the ink composition into a viscosity suitable for printing, and the resulting ink may not be suitably used with a shallow printing plate.

### <Method of Producing Organic Solvent-Based Ink Composition for Gravure Printing Prior to Gravure Printing>

For the use in gravure printing, the organic solvent-based high-solid ink composition for gravure printing of the present invention is diluted with an organic solvent so as to have a viscosity appropriate for printing conditions at an atmospheric temperature during printing. Specifically, the viscosity is preferably about 12 to 23 s/25° C., and for high-speed printing, about 14 to 16 s/25° C. in terms of the efflux time from a Zahn cup #3.

The following will describe a gravure printing method using the organic solvent-based ink composition for gravure printing.

The organic solvent-based ink composition for gravure printing may be printed by a common gravure printing technique. The ink composition may be printed on any base, and examples thereof include polyolefin films such as polyethylene films and polypropylene films, polyester films such as polyethylene terephthalate films, polylactic acid films, and polycaprolactone films, and plastic films for printing such as nylon films and vinylon films. Of course, based on the spirit of the present invention, the base film may be a usual film or a heat-shrinkable film, and the printed film may be subjected to post-processes such as lamination and shrinking treatment.

The printing plate to be used is one (shallow printing plate) having shallower cells than those of conventional cylinders (intaglio plates produced by a usual gravure platemaking technique, and examples of such a printmaking technique include gravure engraving).

In the gravure printing method, printed matter is produced using the organic solvent-based ink composition for gravure printing and the aforementioned shallow printing plate. The printed matter produced by the above method may further be laminated by any of various laminating techniques, and the laminated matter can be used for packaging bags or laminated cans, for example. Examples of such laminating techniques include extrusion lamination in which an anchor coating agent is applied onto the surface of printed matter, and then a molten polymer is laminated thereon; and dry lamination in which an adhesive is applied onto the surface of printed matter, and then a polymer film is attached thereon.

In the extrusion lamination, the surface of printed matter is coated with a titanium-, urethane-, imine-, or polybutadiene-based anchor coating agent as needed, and then a molten polymer is laminated thereon using a known extrusion laminating device. Another material may further be laminated thereon so that the molten resin layer becomes an intermediate layer.

Examples of the molten resin used in the extrusion lamination include conventionally used resins such as low density polyethylene, ethylene-vinyl acetate copolymers, and polypropylene. In particular, use of low density polyethylene, which is easily oxidized in melting to generate carbonyl groups, enhances the effects of the present invention.

In the dry lamination, the surface of printed matter is coated with a urethane- or isocyanate-based adhesive, and then a polymer film is attached thereon using a known dry laminating device. Examples of the polymer film used in the dry lamination include polyethylene films and unstretched polypropylene films. For retort pouch packaging materials, aluminum foil may be interposed between the base and a plastic film to be attached before the lamination. Such laminated products may be first formed into bags, then the contents are charged, and finally used in boiling and retort pouch uses.

In the lamination for production of the laminated can, an adhesive is applied to the surface of printed matter, and the printed matter is attached to a metal sheet.

Specifically, an adhesive is applied to the surface of printed matter using a known application technique such as spray coating, roll coating, or gravure coating, and dried at a temperature of 150° C. to 200° C. The resulting print base including a print ink layer and an adhesive layer is attached to a metal sheet, then subjected to short-time thermal lamination at a temperature of about 100° C. to 250° C. Thus, the printed matter and the metal sheet can be bonded to each other.

Examples of the adhesive include one-pack type or two-pack type polyester resin-based adhesives, polyurethane resin-based adhesives, and epoxy resin-based adhesives.

Examples of the metal sheet include various plated steel sheets such as hot rolled steel sheets, cold rolled steel sheets, hot dip galvanized steel sheets, electrogalvanized steel sheets, iron-zinc alloy plated steel sheets, zinc-aluminum alloy plated steel sheets, nickel-zinc alloy plated steel sheets, nickel-tin alloy plated steel sheets, tinned sheets, chromium-plated steel sheets, aluminum-plated steel plates, terne-plated steel sheets, and nickel-plated steel sheets, metal materials such as stainless steel sheets, tin-free steel sheets, aluminum sheets, steel sheets, and titanium sheets, and those obtained by optionally performing chemical treatment (e.g., phosphate treatment, chromate treatment, or composite oxide film treatment) on these metal materials.

The laminated cans obtained according to the present invention are excellent in adhesiveness of the printed matters thereon after retort treatment.

### Advantageous Effects of Invention

The present invention can provide an organic solvent-based high-solid ink composition for gravure printing which shows good print density, printability, and laminatability even when a shallow printing plate is used in gravure printing.

### DESCRIPTION OF EMBODIMENTS

The present invention will more specifically be described herein below referring to, but not limited to, examples. The symbol “%” herein means “% by mass” and the term “part(s)” herein means “part(s) by mass”, unless otherwise mentioned.

### (Production of Solvent-Based Ink Composition for Gravure Printing)

### <Production Example of Polyurethane Resin Varnish A>

A four-neck flask equipped with a stirrer, a condenser, and a nitrogen gas introduction pipe was charged with 100 parts by mass of 3-methyl-1,5-pentylene adipate diol having an average molecular weight of 2000, 100 parts by mass of polypropylene glycol having an average molecular weight of 2000, and 44.4 parts by mass of isophorone diisocyanate. The materials were reacted at 100° C. to 105° C. for six hours while nitrogen gas was introduced thereinto. The reaction product was left to cool down close to room temperature. Then, 517 parts by mass of ethyl acetate and 91 parts by mass of isopropyl alcohol were added thereto, and 15.6 parts by mass of isophorone diamine was further added to cause a chain extension reaction. Further, 0.70 parts by mass of monoethanolamine was added to react therewith. Then, 1.09 parts by mass of isophorone diamine was added to terminate the reaction, thereby providing a polyurethane resin varnish A (solid content: 30% by mass, viscosity: 240 mPa·s/25° C.).

### <Production Example of Polyurethane Resin Varnish B>

A four-neck flask equipped with a stirrer, a condenser, and a nitrogen gas introduction pipe was charged with 100 parts by mass of 3-methyl-1,5-pentylene adipate diol having an average molecular weight of 2000, 100 parts by mass of polypropylene glycol having an average molecular weight of 2000, and 44.4 parts by mass of isophorone diisocyanate. The materials were reacted at 100° C. to 105° C. for six hours while nitrogen gas was introduced thereinto. The reaction product was left to cool down close to room temperature. Then, 520 parts by mass of ethyl acetate and 92 parts by mass of isopropyl alcohol were added thereto, and 15.6 parts by mass of isophorone diamine was further added to cause a chain extension reaction. Further, 0.50 parts by mass of monoethanolamine was added to react therewith. Then, 1.82 parts by mass of isophorone diamine was added to terminate the reaction, thereby providing a polyurethane resin varnish B (solid content: 30% by mass, viscosity: 240 mPa·s/25° C.).

### <Production Example of Polyurethane Resin Varnish C>

A four-neck flask equipped with a stirrer, a condenser, and a nitrogen gas introduction pipe was charged with 100 parts by mass of 3-methyl-1,5-pentylene adipate diol having an average molecular weight of 2000, 100 parts by mass of polypropylene glycol having an average molecular weight of 2000, and 44.4 parts by mass of isophorone diisocyanate. The materials were reacted at 100° C. to 105° C. for six hours while nitrogen gas was introduced thereinto. The reaction product was left to cool down close to room temperature. Then, 521 parts by mass of ethyl acetate and 92 parts by mass of isopropyl alcohol were added thereto, and 15.6 parts by mass of isophorone diamine was further added to cause a chain extension reaction. Further, 0.31 parts by mass of monoethanolamine was added to react therewith. Then, 2.18 parts by mass of isophorone diamine and 0.17 parts by mass of diethylenetriamine were added to terminate the reaction, thereby providing a polyurethane resin varnish C (solid content: 30% by mass, viscosity: 250 mPa·s/25° C.).

### <Production Example of Polyurethane Resin Varnish D>

A four-neck flask equipped with a stirrer, a condenser, and a nitrogen gas introduction pipe was charged with 100 parts by mass of 3-methyl-1,5-pentylene adipate diol having an average molecular weight of 2000, 100 parts by mass of polypropylene glycol having an average molecular weight of 2000, and 44.4 parts by mass of isophorone diisocyanate. The materials were reacted at 100° C. to 105° C. for six hours while nitrogen gas was introduced thereinto. The reaction product was left to cool down close to room temperature. Then, 522 parts by mass of ethyl acetate and 92 parts by mass of isopropyl alcohol were added thereto, and 15.6 parts by mass of isophorone diamine was further added to cause a chain extension reaction. Further, 0.10 parts by mass of monoethanolamine was added to react therewith. Then, 2.91 parts by mass of isophorone diamine and 0.17 parts by mass of diethylenetriamine were added to terminate the reaction, thereby providing a polyurethane resin varnish D (solid content: 30% by mass, viscosity: 260 mPa·s/25° C.).

### <Production Example of Polyurethane Resin Varnish E>

A four-neck flask equipped with a stirrer, a condenser, and a nitrogen gas introduction pipe was charged with 100 parts by mass of 3-methyl-1,5-pentylene adipate diol having an average molecular weight of 2000, 100 parts by mass of polypropylene glycol having an average molecular weight of 2000, and 44.4 parts by mass of isophorone diisocyanate. The materials were reacted at 100° C. to 105° C. for six hours while nitrogen gas was introduced thereinto. The reaction product was left to cool down close to room temperature. Then, 523 parts by mass of ethyl acetate and 92 parts by mass of isopropyl alcohol were added thereto, and 13.6 parts by mass of isophorone diamine was further added to cause a chain extension reaction. Further, 0.49 parts by mass of monoethanolamine was added to react therewith. Then, 4.76 parts by mass of isophorone diamine and 0.41 parts by mass of diethylenetriamine were added to terminate the reaction, thereby providing a polyurethane resin varnish E (solid content: 30% by mass, viscosity: 200 mPa·s/25° C.).

### <Production Example of Polyurethane Resin Varnish F>

A four-neck flask equipped with a stirrer, a condenser, and a nitrogen gas introduction pipe was charged with 100 parts by mass of 3-methyl-1,5-pentylene adipate diol having an average molecular weight of 2000, 100 parts by mass of polypropylene glycol having an average molecular weight of 2000, and 44.4 parts by mass of isophorone diisocyanate. The materials were reacted at 100° C. to 105° C. for six hours while nitrogen gas was introduced thereinto. The reaction product was left to cool down close to room temperature. Then, 517 parts by mass of ethyl acetate and 91 parts by mass of isopropyl alcohol were added, and 13.6 parts by mass of isophorone diamine was added to cause a chain extension reaction. Further, 2.44 parts by mass of monoethanolamine was added to terminate the reaction, thereby providing a polyurethane resin varnish F (solid content: 30% by mass, viscosity: 200 mPa·s/25° C.).

### <Production Example of Polyurethane Resin Varnish G>

A four-neck flask equipped with a stirrer, a condenser, and a nitrogen gas introduction pipe was charged with 100 parts by mass of 3-methyl-1,5-pentylene adipate diol having an average molecular weight of 2000, 100 parts by mass of polypropylene glycol having an average molecular weight of 2000, and 44.4 parts by mass of isophorone diisocyanate. The materials were reacted at 100° C. to 105° C. for six hours while nitrogen gas was introduced thereinto. The reaction product was left to cool down close to room temperature. Then, 517 parts by mass of ethyl acetate and 91 parts by mass of isopropyl alcohol were added, and 16.3 parts by mass of isophorone diamine was added to cause a chain extension reaction. Further, 0.5 parts by mass of monoethanolamine was added to terminate the reaction, thereby providing a polyurethane resin varnish G (solid content: 30% by mass, viscosity: 1200 mPa·s/25° C.).

### <Production Example of Organic Solvent-Based High-Solid Indigo Ink Composition for Gravure Printing>

First, 20 parts by mass of a pigment (phthalocyanine blue, C.I. 15:4), 30 parts by mass of one of the polyurethane resin varnishes A to G, and 50 parts by mass of one of solvent mixtures A to C were mixed and kneaded using a paint shaker. Then, to 50 parts by mass of the resulting mixture were added one of the polyurethane resin varnishes A to G and one of the solvent mixtures A to C to provide a composition having a formulation shown in Table 1. Thus, an organic solvent-based high-solid indigo ink composition for gravure printing of each of Examples 1 to 7 and Comparative Examples 1 to 4 was obtained.

### <Production Example of Organic Solvent-Based High-Solid White Ink Composition for Gravure Printing>

First, 35 parts by mass of a pigment (titanium oxide), 30 parts by mass of one of the polyurethane resin varnishes A to G, and 10 parts by mass of the solvent mixture A or B were mixed and kneaded using a paint shaker. Then, to the resulting mixture was further added the solvent mixture A or B to provide a composition having a formulation shown in Table 2. Thus, an organic solvent-based high-solid white ink composition for gravure printing of each of Examples 8 to 12 and Comparative Examples 5 to 7 was obtained.

### (Evaluation)

The following shows the methods of evaluating the performance of the respective organic solvent-based high-solid indigo ink compositions for gravure printing prepared in Examples 1 to 7 and Comparative Examples 1 to 4 and of the respective organic solvent-based high-solid white ink compositions for gravure printing prepared in Examples 8 to 12 and Comparative Examples 5 to 7. Tables 1 and 2 show the results.

### <Evaluation of Performance of Ink Composition>

### (Viscosity of Ink)

The organic solvent-based high-solid indigo ink compositions for gravure printing of Examples 1 to 7 and Comparative Examples 1 to 4 and the organic solvent-based high-solid white ink compositions for gravure printing of Examples 8 to 12 and Comparative Examples 5 to 7 were each individually collected in a glass bottle, and the viscosity at a liquid temperature of 25° C. was measured using a B-type viscometer (Tokyo Keiki Inc.) equipped with a rotor #2 at 30 rpm.

### (Storage Stability of Ink)

The organic solvent-based high-solid indigo ink compositions for gravure printing of Examples 1 to 7 and Comparative Examples 1 to 4 and the organic solvent-based high-solid white ink compositions for gravure printing of Examples 8 to 12 and Comparative Examples 5 to 7 were each individually collected in a glass bottle, and they were stored at an atmospheric temperature of 60° C. for 14 days. Based on the presence or absence of sedimentation of the pigment, the storage stability of each ink was evaluated based on the following criteria.

A: No sedimentation occurred and ink had good storage stability.
B: Sedimentation occurred and ink had poor storage stability.

### (Density and Printability)

Each of the organic solvent-based high-solid indigo ink compositions of Examples 1 to 7 and Comparative Examples 1 to 3 and the organic solvent-based high-solid white ink compositions of Examples 8 to 12 and Comparative Examples 5 and 6 (100 parts by mass) was diluted with one of the solvent mixtures A to C in accordance with the formulation of Table 1 or 2, so that the viscosity using a Zahn cup #3 (Rigo Co., Ltd.) of each composition was adjusted to 15 seconds. Then, a polyethylene terephthalate film (Toyobo co., Ltd., E-5101, thickness: 12 μm, hereinafter referred to as a PET film) with one surface subjected to corona discharge treatment was prepared, and the ink was applied onto the treated surface of the PET film at a printing speed of 100 m/min using a gravure printing device (Higashitani Seisakusho K.K.) equipped with an engraved plate (printing plate, Helio 200 lines/inch). This printed matter is also referred to as a printed PET film.

Additionally, the printing was performed in the same conditions using the organic solvent-based high-solid indigo ink composition for gravure printing or the organic solvent-based high-solid white ink composition for gravure printing of Comparative Example 1 or Comparative Example 5 except that a different engraved plate (Helio 175 lines) was used. These examples were taken as Comparative Examples 4 and 7.

### (Print Density)

For the print density, the reflection density of indigo printed matter was measured using a densitometer (RD-918, Macbeth). Also, the transmission density of white printed matter was measured using a densitometer (TR-931, Macbeth).

### (Printability)

The printability was evaluated after the printing based on the ratio of the blurred area, which was due to ink clogging on the plate, to the printed area.

A: No blur was observed at all.
B: Slight blur was observed.
C: Much blur was observed.

### (Laminatability)

The laminatability was evaluated based on the boiling suitability and the retort suitability of each printed PET film.

### (Boiling Suitability)

Each printed PET film 1 day after the printing was coated with an isocyanate-based anchor coating agent (a mixture of TAKELAC A-3072 and TAKENATE A-3210, Mitsui Chemicals Polyurethanes, Inc.), and then polyethylene (SUMIKATHENE L705, Sumitomo Chemical Co., Ltd.) molten at 345° C. was laminated thereon so as to have a thickness of 25 μm using an extrusion laminator. The workpiece was left to stand at 40° C. for 1 day, thereby providing an extrusion-laminated product. This extrusion-laminated product was formed into a bag and the bag was charged with a mixture of 90% by weight of water and 10% by weight of cooking oil. Then, the bag was hot-sealed and immersed in hot water at 90° C. for 60 minutes. The boiling suitability was evaluated based on the presence or absence of delamination.

A: No delamination was observed at all.
B: Pinhole-like delamination was observed or fine short delamination was partially observed.
C: Long striped delamination was observed on the entire surface.

### (Retort Suitability)

Each printed PET film 1 day after the printing was coated with a urethane-based adhesive (a mixture of TAKELAC A-616 and TAKENATE A-65, Mitsui Chemicals Polyurethanes, Inc.) in an amount corresponding to a solid content of 2.0 g/m², and then an unstretched polypropylene film (RXC-3, thickness: 60 μm, Mitsui Chemicals Tohcello. Inc.) was attached thereto using a dry laminator. The workpiece was left to stand at 40° C. for 3 days, thereby providing a dry-laminated product. This dry-laminated product was formed into a bag and the bag was charged with a mixture of 90% by weight of water and 10% by weight of cooking oil. Then, the bag was hot-sealed and immersed in pressurized hot water at 120° C. for 60 minutes. The retort suitability was evaluated based on the presence or absence of delamination. The evaluation was performed on the basis of the same criteria as those for the boiling suitability.

TABLE 1

| | | Indigo ink | | | | | | | | | | |
|---|---|---|---|---|---|---|---|---|---|---|---|---|
| | | Example | Example | Example | Example | Example | Example | Example | Comparative | Comparative | Comparative | Comparative |
| | | 1 | 2 | 3 | 4 | 5 | 6 | 7 | Example 1 | Example 2 | Example 3 | Example 4 |
| Pigment | | 10 | 10 | 10 | 10 | 10 | 10 | 10 | 10 | 10 | 10 | 10 |
| Polyurethane | A | 30 | — | — | — | — | — | — | — | — | — | — |
| resin | B | — | 30 | — | — | — | — | — | — | — | — | — |
| varnish | C | — | — | 30 | 30 | 30 | — | — | — | — | — | — |
| | D | — | — | — | — | — | 30 | — | — | — | — | — |
| | E | — | — | — | — | — | — | 30 | — | — | — | — |
| | F | — | — | — | — | — | — | — | — | — | 30 | — |
| | G | — | — | — | — | — | — | — | 30 | 20 | — | 30 |
| Solvent | Solvent | — | — | 60 | — | — | — | — | 60 | 70 | 60 | 60 |
| | mixture | | | | | | | | | | | |
| | A | | | | | | | | | | | |
| | Solvent | 60 | 60 | — | 60 | — | 60 | 60 | — | — | — | — |
| | mixture | | | | | | | | | | | |
| | B | | | | | | | | | | | |
| | Solvent | — | — | — | — | 60 | — | — | — | — | — | — |
| | mixture | | | | | | | | | | | |
| | C | | | | | | | | | | | |
| Ink viscosity | | 60 | 58 | 55 | 56 | 55 | 52 | 30 | 500 | 200 | 35 | 500 |
| (mPa · s/25° C.) | | | | | | | | | | | | |
| Storage stability of ink | | A | A | A | A | A | A | A | B | B | B | B |
| Diluting | Solvent | — | — | 25 | — | — | — | — | 55 | 35 | 25 | 55 |
| solvent | mixture | | | | | | | | | | | |
| | A | | | | | | | | | | | |
| | Solvent | 25 | 25 | — | 25 | — | 25 | 25 | — | — | — | — |
| | mixture | | | | | | | | | | | |
| | B | | | | | | | | | | | |
| | Solvent | — | — | — | — | 25 | — | — | — | — | — | — |
| | mixture | | | | | | | | | | | |
| | C | | | | | | | | | | | |
| Efflux time of ink from | | 15 | 15 | 15 | 15 | 15 | 15 | 14 | 15 | 15 | 15 | 15 |
| Zahn cup #3 in printing | | | | | | | | | | | | |
| (s/25° C.) | | | | | | | | | | | | |
| Printing | Helio | 200 | 200 | 200 | 200 | 200 | 200 | 200 | 200 lines | 200 lines | 200 lines | 175 lines |
| plate | | lines | lines | lines | lines | lines | lines | lines | | | | |
| Printing | (m/s) | 100 | 100 | 100 | 100 | 100 | 100 | 100 | 100 | 100 | 100 | 100 |
| speed | | | | | | | | | | | | |
| Density | | 2.31 | 2.31 | 2.31 | 2.31 | 2.31 | 2.31 | 2.31 | 2.21 | 2.27 | 2.31 | 2.30 |
| Printability | | A | A | B | A | A | A | A | A | C | B | B |
| Laminat- | Boiling | A | A | A | A | A | A | A | B | C | B | B |
| ability | Retorting | A | A | A | A | A | A | A | B | C | B | B |

Solvent mixture: Ethyl acetate/IPA = 75/25 (mass ratio)
Solvent mixture B: Ethyl acetate/Propyl acetate/IPA = 50/25/25 (mass ratio)
Solvent mixture C: Propyl acetate/IPA = 75/25 (mass ratio)

TABLE 2

| | | White ink | | | | | | | |
|---|---|---|---|---|---|---|---|---|---|
| | | Example | Example | Example | Example | Example | Comparative | Comparative | Comparative |
| | | 8 | 9 | 10 | 11 | 12 | Example 5 | Example 6 | Example 7 |
| Pigment | | 35 | 35 | 35 | 35 | 35 | 35 | 35 | 35 |
| Polyurethane | A | 30 | — | — | — | — | — | — | — |
| resin | B | — | 30 | — | — | — | — | — | — |
| varnish | C | — | — | 30 | — | — | — | — | — |
| | D | — | — | — | 30 | — | — | — | — |
| | E | — | — | — | — | 30 | — | — | — |
| | F | — | — | — | — | — | — | 30 | — |
| | G | — | — | — | — | — | 30 | — | 30 |
| Solvent | Solvent mixture A | — | — | — | — | — | 35 | 35 | 35 |
| | Solvent mixture B | 35 | 35 | 35 | 35 | 35 | — | — | — |
| | Solvent mixture C | — | — | — | — | — | — | — | — |
| Ink viscosity (mPa · s/25° C.) | | 82 | 80 | 77 | 75 | 65 | 250 | 70 | 250 |
| Storage stability of ink | | A | A | A | A | A | B | B | B |
| Diluting solvent | Solvent mixture A | — | — | — | — | — | 50 | 25 | 50 |
| | Solvent mixture B | 25 | 25 | 25 | 25 | 25 | — | — | — |
| | Solvent mixture C | — | — | — | — | — | — | — | — |
| Efflux time of ink from Zahn cup | | 15 | 15 | 15 | 15 | 14 | 15 | 15 | 15 |
| #3 in printing (s/25° C.) | | | | | | | | | |
| Printing plate | Helio | 200 lines | 200 lines | 200 lines | 200 lines | 200 lines | 200 lines | 200 lines | 175 lines |
| Printing speed | (m/s) | 100 | 100 | 100 | 100 | 100 | 100 | 100 | 100 |
| Density | | 0.36 | 0.36 | 0.36 | 0.36 | 0.36 | 0.33 | 0.36 | 0.36 |
| Printability | | A | A | A | A | A | A | B | B |
| Laminatability | Boiling | A | A | A | A | A | B | B | B |
| | Retorting | A | A | A | A | A | B | B | B |

Solvent mixture: Ethyl acetate/IPA = 75/25 (mass ratio)
Solvent mixture B: Ethyl acetate/Propyl acetate/IPA = 50/25/25 (mass ratio)
Solvent mixture C: Propyl acetate/IPA = 75/25 (mass ratio)

As shown in Tables 1 and 2, the organic solvent-based high-solid indigo ink compositions for gravure printing or the organic solvent-based high-solid white ink compositions for gravure printing in the examples showed good print density, printability, and laminatability even in gravure printing using a shallow cylinder. The ink compositions in Examples 1, 2, and 4 to 12 using propyl acetate as a diluting solvent showed better printability than the ink composition in Example 3 containing no propyl acetate.

No organic solvent-based high-solid indigo ink composition for gravure printing or the organic solvent-based high-solid white ink composition for gravure printing was excellent in all of the print density, printability, and laminatability according to the comparative examples.

### INDUSTRIAL APPLICABILITY

The present invention can provide an organic solvent-based high-solid ink composition for gravure printing which shows good print density, printability, and laminatability even in gravure printing using a shallow cylinder.

1. An organic solvent-based high-solid ink composition for gravure printing, mainly comprising:
a pigment;
a binder resin; and
an organic solvent,
the high-solid ink composition having a viscosity of 10 to 1000 mPa·s/25° C. and having a viscosity in gravure printing of 12 to 23 s/25° C. in terms of the efflux time from a Zahn cup #3,
the pigment comprising at least one of an organic pigment and an inorganic pigment,
the binder resin comprising a polyurethane resin having at least one of a primary amino group and a secondary amino group at an end,
the polyurethane resin in an amount of 30 parts by mass, when dissolved in 70 parts by mass of the organic solvent, providing a solution having a viscosity of 100 to 900 mPa·s/25° C.,
the pigment and the binder resin satisfying the following conditions 1 to 3:
Condition 1: with the pigment being an organic pigment, the amount of the organic pigment being 5 to 20% by mass and the amount of the polyurethane resin being 3 to 20% by mass in the organic solvent-based high-solid ink composition for gravure printing; and the amount of the polyurethane resin being 70 to 200 parts by mass relative to 100 parts by mass of the organic pigment;
Condition 2: with the pigment being an inorganic pigment, the amount of the inorganic pigment being 5 to 70% by mass and the amount of the polyurethane resin being 3 to 20% by mass in the organic solvent-based high-solid ink composition for gravure printing; and the amount of the polyurethane resin being 5 to 60 parts by mass relative to 100 parts by mass of the inorganic pigment; and
Condition 3: with the pigment including both an organic pigment and an inorganic pigment, the amount of the organic pigment being 5 to 20% by mass, the ratio by mass of the inorganic pigment to the organic pigment ((mass of inorganic pigment)/(mass of organic pigment)) satisfying 0<((mass of inorganic pigment)/(mass of organic pigment)<7.0, and the amount of the polyurethane resin being 6 to 20% by mass in the organic solvent-based high-solid ink composition for gravure printing; and the amount of the polyurethane resin being 20 to 200 parts by mass relative to 100 parts by mass of the whole pigments.

2. The organic solvent-based high-solid ink composition for gravure printing according to claim 1,
wherein the polyurethane resin having at least one of a primary amino group and a secondary amino group at an end is obtained by reacting a urethane prepolymer having an isocyanate group at an end which is prepared by reacting a polymer diol and polyisocyanate, with a polyamine compound having at least one of a primary amino group and a secondary amino group at an end.

3. The organic solvent-based high-solid ink composition for gravure printing according to claim 2,
wherein the polyurethane resin having at least one of a primary amino group and a secondary amino group at an end is obtained by any of the following methods (1) to (4):
(1) a urethane prepolymer having an isocyanate group at an end which is obtained by reacting a polymer diol and polyisocyanate is subjected to chain extension with use of an chain extender to provide a urethane prepolymer having an isocyanate group at an end, and the urethane prepolymer is reacted with a quencher other than a polyamine compound having at least one of a primary amino group and a secondary amino group at both ends and then with a quencher that is a polyamine compound having at least one of a primary amino group and a secondary amino group at both ends, thereby preparing a polyurethane resin having at least one of a primary amino group and a secondary amino group;
(2) a urethane prepolymer having an isocyanate group at an end which is obtained by reacting a polymer diol and polyisocyanate is subjected to chain extension with use of an chain extender to provide a urethane prepolymer having an isocyanate group at an end, and the urethane prepolymer is reacted simultaneously with a quencher other than a polyamine compound having at least one of a primary amino group and a secondary amino group at both ends and a quencher that is a polyamine compound having at least one of a primary amino group and a secondary amino group at both ends, thereby preparing a polyurethane resin having at least one of a primary amino group and a secondary amino group;
(3) a urethane prepolymer having an isocyanate group at an end which is obtained by reacting a polymer diol and polyisocyanate is subjected to chain extension with use of an chain extender to provide a urethane prepolymer having an isocyanate group at an end, and the urethane prepolymer is reacted with a quencher that is a polyamine compound having at least one of a primary amino group and a secondary amino group at both ends, thereby preparing a polyurethane resin having at least one of a primary amino group and a secondary amino group; and
(4) a urethane prepolymer having an isocyanate group at an end which is obtained by reacting a polymer diol and polyisocyanate is reacted with a polyamine compound having at least one of a primary amino group and a secondary amino group at both ends to be subjected to chain extension and reaction termination at the same time, thereby preparing a polyurethane resin having at least one of a primary amino group and a secondary amino group.

4. The organic solvent-based high-solid ink composition for gravure printing according to claim 1,
wherein the polyurethane resin is a polyurethane resin having a primary amino group at an end.

5. The organic solvent-based high-solid ink composition for gravure printing according to claim 1,
wherein the organic solvent is a solvent mixture of an ester-based organic solvent and an alcoholic organic solvent.

6. The organic solvent-based high-solid ink composition for gravure printing according to claim 5, which is to be diluted with an organic solvent to provide an organic solvent-based ink composition for gravure printing prior to gravure printing,
wherein the organic solvent is a solvent mixture of an ester-based organic solvent and an alcoholic organic solvent,
the ratio of the ester-based solvent and the alcoholic organic solvent ((ester-based organic solvent/alcoholic organic solvent) in the organic solvent-based ink composition for gravure printing is 50/50 to 95/5.

7. The organic solvent-based high-solid ink composition for gravure printing according to claim 6,
wherein the organic solvent-based ink composition for gravure printing contains 5% by mass or more of propyl acetate as an ester-based solvent.

8. A gravure printing method using the organic solvent-based high-solid ink composition for gravure printing according to claim 1, the method comprising:
preparing an organic solvent-based ink composition for gravure printing by diluting the organic solvent-based high-solid ink composition for gravure printing with an organic solvent; and
producing printed matter by gravure printing using the organic solvent-based ink composition for gravure printing and a shallow gravure cylinder.
